(19) United States
(12) Patent Application Publication
(10) Pub. No.: US 2024/0239304 A1
(43) Pub. Date: Jul. 18, 2024

(54) LIQUID DEVICE OF A MOTOR VEHICLE

(71) Applicant: MERCEDES-BENZ GROUP AG, Stuttgart (DE)

(72) Inventor: Steven PETERS, Schwieberdingen (DE)

(21) Appl. No.: 18/289,830

(22) PCT Filed: Apr. 27, 2022
(86) PCT No.: PCT/EP2022/061276

§ 371 Date: Nov. 7, 2023

(30) Foreign Application Priority Data
May 11, 2021 (DE) 10 2021 002 499.0

(51) Int. Cl. B60S 1/48; B60Q 1/26; B60S 1/50

(52) U.S. Cl. CPC B60S 1/481; B60Q 1/2684; B60S 1/50

(57) ABSTRACT

A liquid device generates a liquid jet on an outer region of a motor vehicle. The liquid device includes a liquid outlet via which the liquid jet, generated by a pump and fed from a tank, emerges in the outer region of the motor vehicle. The liquid device also includes a liquid container having a liquid inlet in which the liquid jet emerging from the liquid outlet can be received in the outer region of the motor vehicle and which is connected via a conduit to the tank.

### BACKGROUND AND SUMMARY OF THE INVENTION

Exemplary embodiments of the invention relate to a liquid device and to a method for operating such a liquid device.

DE 10 2012 006 754 A1 discloses a system consisting of multiple units, each of which consists of a water tank, a water pump, connecting hoses, and an outer knob or outer tube. The outer knobs or outer tubes are fastened on the body in such a way that the output nozzles pivot outwards because of the pressure of the water jets. The system can be started and controlled both from an inside of the vehicle and from the outside, and by remote control.

Exemplary embodiments of the invention are directed to a liquid device and a method by means of which a liquid jet can be conveyed to a corresponding liquid container.

The liquid device according to the invention for generating a liquid jet on an outer region of a motor vehicle comprises a liquid outlet via which the liquid jet generated by means of a pump device and fed from a tank emerges in the outer region of the motor vehicle.

In order to create a liquid device by means of which the liquid jet can be conveyed to a corresponding liquid container, it is provided according to the invention that the liquid device comprises a liquid container with a liquid inlet in which the liquid jet emerging from the liquid outlet can be received in the outer region of the motor vehicle. Furthermore, the liquid inlet is connected to the tank via a conduit. In other words, a pump is fed with liquid from the tank and the liquid is conveyed by means of the liquid outlet as a liquid jet into a surrounding environment of the liquid device. The liquid jet passes through a trajectory to the liquid container and its liquid inlet. The liquid is again guided from the liquid container into the tank by means of the conduit, thereby completing the circuit of the liquid.

In this case, the liquid outlet is arranged, for example, in the vehicle longitudinal direction in a frontal outer region of the motor vehicle, and the liquid inlet is arranged in the vehicle longitudinal direction in a rear outer region. In this case, the liquid outlet is designed to convey the liquid jet into the rear outer region at an angle between to the rear in the vehicle longitudinal direction and upward in the vertical direction of the vehicle, where the liquid inlet and the liquid container are arranged. In other words, it is possible by means of the liquid device to allow a liquid jet to flow out of the liquid outlet with its trajectory in such a way that the liquid jet arrives in the liquid container. In this case, the liquid inlet is, for example, at least partially conical, so that a tolerance for compensation of different, for example, wind-induced, trajectories is possible.

The pump device is also designed to convey the liquid into the tank via the conduit when the liquid jet enters the liquid container, whereby a small amount of liquid is retained in relation to the volume of the liquid container, and the rest is fed into the circuit. This results in the tank being filled with liquid in order to continue to discharge the liquid jet. In addition, it is possible, in particular, to discharge not only a liquid jet by means of the pump device, but also a plurality thereof, which are discharged sequentially. In other words, an integration of a liquid device or a water storage device is hereby possible, which by means of the pump device enables short liquid jets or sequences of a water jet or water stream from a front of the motor vehicle in the direction of the rear. The water is collected there and returned again so that a small amount of entrained liquid or water in a small tank is sufficient to give rise to an optical water fountain effect in the outer region of the motor vehicle.

An advantageous embodiment of the invention provides that the liquid jet can be conducted in a trajectory from the liquid outlet to the liquid container. In this case, it is possible, for example, to design the liquid container such that it is fastened at least partially tilted forward in the vehicle longitudinal direction, in particular at an angle of incidence of the trajectory of the liquid jet into the liquid inlet. An adjustable design of the liquid container in this case enables several angles, as a result of which this angle can be set, for example, by means of a control device and an actuator. Likewise, a corresponding control of the liquid outlet can adapt the exit angle of the liquid jet. Thus, the trajectory of the liquid jet is at least partially controllable.

In a further advantageous embodiment of the invention, it is provided that the liquid outlet is arranged in a frontal outer region of the motor vehicle and the liquid inlet is arranged in a rear outer region of the motor vehicle. The frontal outer region is provided, in particular, by a front hood of the motor vehicle. In particular, the liquid outlet is arranged at a front central region of the front hood in the vehicle longitudinal direction. In this case, it is possible to arrange the liquid outlet below a cover element, in particular below an emblem of the motor vehicle, wherein when the liquid device is used, the cover element can be hinged open or extended by means of a further actuator of the liquid device, and the liquid outlet can be designed to be extendable.

The liquid inlet is arranged, in particular, on a rear central region of the rear in the vehicle longitudinal direction. It is possible here to arrange the liquid inlet below a second cover element, in particular under an antenna of the motor vehicle, wherein the cover element can be hinged out by means of the actuator of the liquid device when the liquid device is used, and the liquid inlet can be extended.

In another advantageous embodiment of the invention, the liquid device comprises a light source, in particular a laser beam, by means of which the liquid jet can be illuminated. In this case, the light source is arranged, for example, at a position from which the light source illuminates or radiates the liquid jet, for example, in a colored manner and, in addition to the water fountain effect, generates a light effect.

A further advantageous embodiment of the invention provides that an amount of liquid from at least one further component of the motor vehicle can be fed into the tank by means of at least one further conduit connected to the tank. In this case, the further component is provided, for example, as an air-conditioning system of the motor vehicle in which liquid is produced, and can be removed therefrom. The feed can be controlled, for example, by means of the further conduit and by means of the pump device and corresponding valves.

In addition, it is provided in a further advantageous embodiment of the invention that the liquid device can be controlled by means of an at least partially automated switch unit. In particular when the motor vehicle is parked, the switch unit can be actuated manually and/or at least partially in an automated manner, such that the liquid device can be switched on for optical effects. In particular, it is electronically couplable to an electrical computing device and/or a driver assistance system of the motor vehicle, as a result of which a remote control via, for example, an ID transmitter or a remote-controlled key is also possible. Furthermore, the liquid device can also be controlled by means of a mobile telephone and corresponding applications which can be coupled wirelessly to the motor vehicle. It is also possible to adjust the liquid jet and the light source by means of remote control.

An embodiment of the invention has also been found to be advantageous in which at least one further, second liquid outlet is included in the arrangement, with a corresponding second pump device, and at least one further second liquid container is included, with a second liquid inlet. In this case, at least one second liquid jet can be conveyed in a manner analogous to the liquid jet. In other words, at least one second liquid jet can thus be generated, in particular a plurality thereof, by which the water fountain effect is further enhanced. In particular, all liquid outlets and liquid inlets are connected to the same tank, as a result of which a circuit is obtained.

In addition, a further embodiment of the invention has proven to be advantageous in which multiple liquid jets can be received in a liquid container. This means that, independently of the plurality of liquid jets, the one liquid container is designed to receive all liquid jets. For this purpose, for example, an angle change of the liquid container in all degrees of freedom is conceivable by means of a movement device provided for this purpose.

A further advantageous embodiment of the invention provides that multiple liquid jets can be controlled independently of one another. It is thus possible to design different liquid jets such that different forms and temporally coordinated effects are possible. An optimized design of the water fountain effect and the light effect is possible in conjunction with the light source. The light effects can be expanded, for example, with a loudspeaker and associated acoustics. Thus, it is possible, for example, to add water noise in addition to the water fountain effect, as well as to adjust, for example, suitable music or further sounds. Finally, the plurality of liquid jets can be controlled by means of a sensor device, via which they can be switched on and off at least partially automatically. When approaching, for example, a person passing by the motor vehicle, the liquid device can be switched on by means of the sensor device. After the person has passed, the liquid device automatically switches off again, as a result of which energy savings is possible. This is also possible by means of a timer for the liquid device. The timer actuates the liquid device after a predetermined time, thereby also enabling energy savings. In addition, in the case of a plurality of liquid devices, it is possible to enhance and optimize the water fountain effect by means of individual timers for each.

A further aspect of the invention relates to a method for operating a liquid device for generating a liquid jet on an outer region of a motor vehicle, in which a liquid jet emerging via a liquid outlet, generated by means of a pump device, and fed from a tank, is provided in the outer region of the motor vehicle. The method is characterized in that the liquid jet emerging from the liquid outlet is received by means of a liquid container comprising a liquid inlet, which liquid container is arranged in the outer region of the motor vehicle and is connected to the tank via a conduit.

In summary, the invention describes a water storage device or a water fountain device having a water supply in an outer region of the motor vehicle. An outflow strength and an outflow direction are two required parameters for the trajectory of the liquid jet, wherein the liquid jet is brought about by means of the pump device and the actuators.

Further advantages, features and details of the invention will be apparent from the following description of a preferred exemplary embodiment and from the drawing. The features and combinations of features mentioned above in the description, along with the features and combinations of features mentioned below in the FIGURE description and/or shown alone in the FIGURE, can be used not only in the combination indicated in each case, but also in other combinations or on their own, without departing from the scope of the invention.

### BRIEF DESCRIPTION OF THE DRAWING FIGURES

The sole FIGURE shows a perspective view of a motor vehicle having a liquid device according to the invention, during operation.

In the sole FIGURE, elements that are identical or have the same function are provided with the same reference signs.

### DETAILED DESCRIPTION

The sole FIGURE shows a perspective view of an outer region 10 of a motor vehicle 12, in particular a frontal outer region 10a and a rear outer region 10b, with a liquid device 14, during operation. In this case, the liquid device 14 has a liquid outlet 16, a pump device 18, and a tank 20, as well as three conduit regions 22a, 22b, 22c of a conduit 22 connecting a liquid container 24 to the tank 20, wherein the liquid container 24 has a liquid inlet 26. In other words, the liquid device 14 is designed to discharge a liquid jet 28, wherein the liquid jet 28, which is generated by means of the pump device 18 and fed from the tank 20, reaches the liquid container 24 via a liquid outlet 16. The liquid jet 28 can be received in the liquid container 24 via the liquid inlet 26, wherein the liquid container 24 is connected to the tank 20 by means of the first conduit region 22a. The tank 20 is connected to the pump device 18 with the second conduit region 22b and with the liquid outlet 16 via the third conduit region 22c so that a circuit is completed when the liquid device 14 is used.

The frontal outer region 10a is provided by a hood 30 of the motor vehicle 12. In this case, the liquid outlet 16 is arranged on a front region 32 of the hood 30 in the vehicle longitudinal direction x, in particular in a central region 34 of the front region 32 in the vehicle transverse direction y. In this case, the liquid outlet 16 is arranged below a first cover element 36, in particular below an emblem of the motor vehicle 12, wherein, when the liquid device 14 is used, the cover element 36 can be hinged out or extended by means of a first actuator 38 of the liquid device 14, and the liquid outlet 16 is exposed by lifting in the vertical direction z of the vehicle, by means of a second actuator 40 of the liquid device 14.

The rear outer region 10b is provided by a rear 44 of the motor vehicle 12. In this case, the liquid inlet 26 is arranged on a rear region 46 of the rear 44 in the vehicle longitudinal direction x, in particular in a middle region 48 of the rear region 46 in the vehicle transverse direction y. In this case, the liquid inlet 26 is arranged below a second cover element 50, in particular under an antenna of the motor vehicle 12, wherein, when the liquid device 14 is used, the second cover element 50 can be hinged out by means of a third actuator 52 of the liquid device 14, and the liquid inlet 26 is exposed by means of a fourth actuator 54 of the liquid device 14 in the vehicle vertical direction z, it being possible to tilt the liquid container 24 by means of a fifth actuator 56 of the liquid device 14. By means of the pump device 18, it is possible to control a liquid jet 28 with respect to an outflow direction 58 and/or outflow strength 60. The liquid jet 28 can be generated in this way.

Furthermore, a light source 62, in particular a laser beam, is arranged on the liquid device 14, which light source illuminates the liquid jet 28, for example. In this case, the light source 62 is arranged, for example, at a position 64 from which the light source 62 illuminates the liquid jet 28 and, in addition to a resulting water fountain effect, a light effect is generated from the optical display. The light source 62 can also be arranged at another position of the motor vehicle 12, for example in the region of its rear.

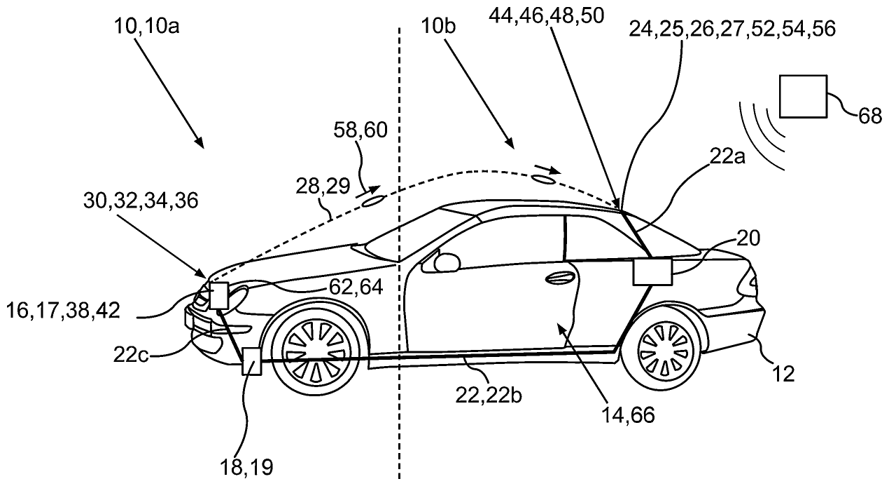

In addition, an amount of liquid from at least one further component of the motor vehicle 12 can be fed into the tank 20 by means of at least one further second conduit connected to the tank 20 and not visible in the single FIG. 1. In this case, the further component likewise not visible in the single FIG. 1 is provided, for example, as an air conditioner of the motor vehicle 12, from which liquid can be removed. In this case, the feed is controllable by means of the further second conduit and by means of the pump device 18 and corresponding valves.

Finally, an at least partially automated switch unit 66 is assigned to the liquid device 14. The switch unit 66 can be actuated manually and/or at least partially in an automated manner in particular when the motor vehicle 12 is parked, as a result of which the liquid device 14 can be switched on for optical effects. In particular, it is electronically couplable to an electrical computing device and/or a driver assistance system of the motor vehicle 12, such that the liquid device 14 can also be switched on via a remote control 68, for example an ID transmitter or a remote-controlled key. Furthermore, it can be switched on by means of mobile telephones and applications which can be coupled wirelessly to the motor vehicle 12. Likewise, the adjustment of the liquid jet 28 and the light source 62 is possible by means of the remote control 68.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the FIGURES enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A device configured to generate a liquid jet on an outer region of a motor vehicle, the device comprising:
a tank of the motor vehicle;
a pump of the motor vehicle coupled to the tank;
a liquid outlet of the motor vehicle coupled to the pump, wherein the liquid outlet is configured to emit the liquid jet generated by the pump and fed from the tank so that the liquid jet emerges in the outer region of the motor vehicle;
a liquid container with a liquid inlet configured to receive the liquid jet from the liquid outlet in the outer region of the motor vehicle, wherein the liquid container is coupled to the tank via a conduit.

12. The device of claim 11, wherein the liquid jet emitted from the liquid outlet has a trajectory from the liquid outlet to the liquid container.

13. The device of claim 12, wherein the liquid outlet is arranged in a frontal outer region of the motor vehicle, and the liquid inlet is arranged in a rear outer region of the motor vehicle.

14. The device of claim 11, further comprising:
a light source configured to illuminate the liquid jet.

15. The device of claim 11, further comprising:
at least one further conduit connected to the tank, wherein the at least one further conduit is configured to feed an amount of liquid from at least one further component of the motor vehicle into the tank.

16. The device of claim 11, further comprising:
an at least partially automated switch unit configured to control the device.

17. The device of claim 11, further comprising:
at least one further second liquid outlet coupled to a corresponding second pump; and
at least one further second liquid container coupled to a second liquid inlet, wherein the at least one further second liquid outlet is configured to emit at least one second liquid jet generated by the second pump.

18. The device of claim 11, wherein the liquid container is configured to receive a plurality of liquid jets.

19. The device of claim 18, wherein the plurality of liquid jets independently controllable of one another.

20. A method for operating a device configured to generate a liquid jet on an outer region of a motor vehicle, the device comprising a tank of the motor vehicle and a pump of the motor vehicle coupled to the tank, the method comprising:
generating, by the pump, a liquid jet using fluid feed from the tank;
emitting, by a liquid outlet of the motor vehicle coupled to the pump, the liquid jet in the outer region of the motor vehicle;
receiving, by a liquid container with a liquid inlet, the liquid jet emitted by the liquid outlet in the outer region of the motor vehicle, wherein the liquid container is arranged in the outer region of the motor vehicle; and
providing, by the liquid container via a conduit, fluid received from the liquid jet to the tank.
